(19) United States
(12) Patent Application Publication
(10) Pub. No.: US 2026/0155649 A1
(43) Pub. Date: Jun. 4, 2026

(54) OVERVOLTAGE PROTECTION DEVICE

(71) Applicant: STMICROELECTRONICS INTERNATIONAL N.V., Geneva (CH)

(72) Inventors: Yannick HAGUE, Saint-Cyr-Sur-Loire (FR); Romain LAUNOIS, TOURS (FR)

(21) Appl. No.: 19/401,921

(22) Filed: Nov. 26, 2025

(30) Foreign Application Priority Data
Dec. 4, 2024 (FR) 2413407

(51) Int. Cl. H02H 9/04

(52) U.S. Cl. CPC H02H 9/045

(57) ABSTRACT

An overvoltage protection device and overvoltage protection method are provided. An example overvoltage protection device includes, between a first terminal and a second terminal: a first Zener diode; a serial assembly comprising a varistor, a first capacitor and a thyristor, having its gate terminal coupled to the first terminal; and a first resistor parallelly arranged with the first capacitor. An example overvoltage protection method uses the overvoltage protection device.

### CROSS REFERENCE TO RELATED APPLICATION(S)

This application claims the priority benefit of French Patent Application Number FR2413407, filed on Dec. 4, 2024, entitled “DISPOSITIF DE PROTECTION CONTRE LES SURTENSIONS”, which is hereby incorporated by reference to the maximum extent allowable by law.

### TECHNICAL FIELD

The present disclosure relates generally to the electronic systems and devices, and more particularly to the protection of these systems and devices against different physical phenomena. The present disclosure relates more especially to protecting electronic systems and devices against overvoltage.

### BACKGROUND

It is nowadays essential to provide the electronic systems and devices with overvoltage or overcurrent protection circuits. Indeed, the occurrence of an overvoltage or overcurrent can seriously damage a non-protected system or device.

It would be desirable to be able to improve at least in part some aspects of overvoltage protection circuits.

### BRIEF SUMMARY

There is a need for a more efficient overvoltage protection device.

There is a need for an overvoltage protection device protecting a DC voltage bus.

There is a need for an overvoltage protection device protecting a DC voltage bus allowing an overvoltage higher than 900 V to be stopped.

One embodiment overcomes all or part of drawbacks in known overvoltage protection devices.

One embodiment overcomes all or part of drawbacks in known overvoltage protection methods.

One embodiment provides an overvoltage protection device comprising, between a first terminal and a second terminal:
a first Zener diode;
a serial assembly comprising a varistor, a first capacitor and a thyristor, having its gate terminal coupled to the first terminal, and
   a first resistor parallelly arranged with the first capacitor.

Another embodiment provides an overvoltage protection method using an overvoltage protection device comprising, between a first terminal and a second terminal:
a first Zener diode;
a serial assembly comprising a varistor, a first capacitor and a thyristor, having its gate terminal coupled to the first terminal, and
   a first resistor parallelly arranged with the first capacitor.

According to an embodiment, a cathode terminal of the thyristor is coupled to the second terminal, and an anode terminal of the thyristor is coupled to the first terminal.

According to an embodiment, a cathode terminal of the first Zener diode is coupled to the first terminal, and an anode terminal of the first Zener diode is coupled to the second terminal.

According to an embodiment, the device further comprises at least one second resistor serially arranged with the first Zener diode.

According to an embodiment, the device further comprises at least one third resistor serially arranged between the gate of the thyristor and the second terminal.

According to an embodiment, the device further comprises at least one second Zener diode serially arranged with the first Zener diode.

According to an embodiment, the device further comprises at least one second capacitor serially arranged with the first capacitor.

Another embodiment provides a direct voltage transmission bus comprising a device described previously suitable for protecting the bus against overvoltage.

According to an embodiment, the bus comprises a three-phase connector.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an example electronic system using an embodiment of an overvoltage protection device;

FIG. 2 illustrates an embodiment of an overvoltage protection device;

FIG. 3 illustrates another embodiment of an overvoltage protection device;

FIG. 4 illustrates graphs illustrating the operation of the embodiment shown in FIG. 3; and

FIG. 5 illustrates other graphs illustrating the operation of the embodiment shown in FIG. 3.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10 %, and preferably within 5 %.

The embodiments described hereinafter relate to the implementation of a protection against overvoltage, and more particularly the implementation of a protection against overvoltage exceeding 900 V that can occur on a DC voltage bus, i.e. a bus suitable for providing a DC voltage. The embodiments described hereinafter relate to an overvoltage protection device, and a protection method using this device. This device comprises a thyristor turned ON upon detecting an overvoltage. However, this thyristor can undergo issues, and remain conductive after the occurrence of an overvoltage, while the embodiments described hereinafter further comprise a capacitor or a resistor parallelly mounted together allowing the current contribution at the thyristor to be reduced, and thus its turning OFF, i.e. the fact to turn non-conductive, to be guaranteed after the occurrence of an overvoltage.

In addition, the embodiments described hereinafter are very particularly suitable for being used in the fields for which a DC voltage bus is used, as the fields of electric vehicles, DC charging stations for electric vehicles, the field of thyristors, the field of power electronics using thyristors, the field of data centers intended, for example, to implement artificial intelligence programs.

More generally, the embodiments described hereinafter are particularly suitable for use in any type of industrial market requiring an overvoltage protection. More particularly, such an overvoltage protection could be intended to:
automotive industry, for example in the automotive electrification field, or in the field of Advanced Driver Assistance Systems (ADAS);
industrial industry, for example in the green energy field, in the field of infrastructure electrification, of Internet of Things (IoT), and of smart home, where the power and energy consumption and data exchange are key elements; and
industry of communications equipment, computers, and peripherals, such as in the field of infrastructure and data centers.

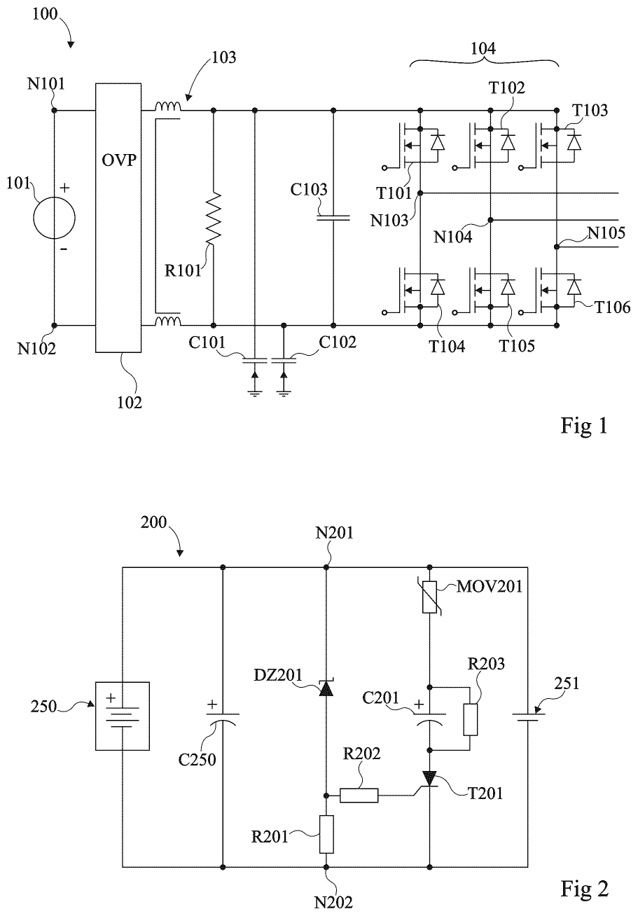

FIG. 1 is a circuit diagram of an example embodiment of a bus 100 transmitting a DC voltage, i.e. a DC bus 100 suitable for providing a DC voltage to an electronic device.

The bus 100 is illustrated by two rails N101 and N102.

The bus 100 is suitable for receiving a DC voltage from a DC voltage source 101. A first terminal of the source 101 is coupled, preferably connected, to rail N101, and a second terminal of the source 101 is coupled, preferably connected, to node N102. According to one example, the voltage source 101 is part of bus 100. Alternatively, the voltage source 101 can be outside the bus 100. According to one example, the voltage source 101 is suitable for providing a DC voltage of between 0 and 1,500 V. According to a specific example, the bus 100 is suitable for providing a high voltage, so that the voltage source 101 is suitable for providing a voltage of between 200 and 1,500 V.

The bus 100 further comprises an overvoltage protection device 102 (OVP) being directly parallelly coupled to the terminals of the voltage source 101. This device 102 is suitable for filtering the overvoltage so that the other components of the bus 100 and the electronic devices using bus 100 are not damaged. Two embodiments of protection devices and their operation are described in detail in connection to FIGS. 2 to 5.

According to one example, the bus 100 further comprises a common mode inductor 103 represented by two coils. According to one example, a first coil is serially coupled to the first rail N101. According to one example, a second coil is serially coupled to the second rail N102. Inductor 103 is aimed to reduce the electromagnetic noise using a coupling.

According to one example, the bus 100 further comprises a resistor R101 arranged for example in parallel to the protection device 102. According to an example, resistor R101 allows to discharge a capacitor mounted in parallel with it, for example capacitor C103 described hereafter.

According to one example, the bus 100 further comprises two filtering capacitors C101 and C102. According to one example, a first filtering capacitor C101 couples, preferably connects, the first rail N101 to a reference potential. According to one example, the second filtering capacitor C102 couples, preferably connects, the second rail N102 to the reference potential.

According to one example, the bus 100 further comprises a capacitor C103 arranged, for example, in parallel to the protection device 102. According to one example, the protection device 102 is sized to protect the capacitor C103 against overvoltage.

According to one example, the bus 100 is suitable for providing a three-phase AC voltage. To this end, the bus 100 comprises a three-phase connector 104. The three-phase connector 104 comprises six transistors T101 to T106. According to one example, the transistors T101 to T106 are metal-oxide-semiconductor field-effect transistors, or MOSFET transistors, or MOS transistors. In addition, the transistors T101 to T106 are N-channel MOS transistors, or N-type MOS transistors, or NMOS transistors. According to another example, transistors T101 to T106 may be insulated gate bipolar transistors (IGBT).

According to one example, a drain terminal of the transistor T101 is coupled, preferably connected, to the first rail N101, and a source terminal of the transistor T101 is coupled, preferably connected, to a first output N103. According to one example, a drain terminal of the transistor T102 is coupled, preferably connected, to the first rail N101, and a source terminal of the transistor T102 is coupled, preferably connected, to a second output N104. According to one example, a drain terminal of the transistor T103 is coupled, preferably connected, to the first rail N101, and a source terminal of the transistor T103 is coupled, preferably connected, to a fourth output N105.

According to one example, a drain terminal of the transistor T104 is coupled, preferably connected, to the first output N103, and a source terminal of the transistor T104 is coupled, preferably connected, to the second rail N102. According to one example, a drain terminal of the transistor T105 is coupled, preferably connected, to the second output N104, and a source terminal of the terminal T104 is coupled, preferably connected, to the second rail N102. According to one example, a drain terminal of the transistor T106 is coupled, preferably connected, to the third output N105, and a source terminal of the transistor T106 is coupled, preferably connected, to the second rail N102.

FIG. 2 is a circuit diagram of a first embodiment of an overvoltage protection device 200.

According to one example, in FIG. 2, a voltage source 250 and a capacitor C250 to be protected are also illustrated. More particularly, the capacitor C250 comprises a first terminal coupled, preferably connected, to a first terminal of the voltage source 250, and a second terminal coupled, preferably connected, to a second terminal of the voltage source 250.

According to one example, in FIG. 2, is also illustrated a voltage source 251 suitable for simulating an overvoltage.

Device 200 comprises two terminals N201 and N202. According to one example, the terminal N201 is coupled, preferably connected, to the first terminal of the voltage source 250, to the first terminal of capacitor C250, and to a first terminal of the voltage source 251. According to one example, the terminal N202 is coupled, preferably connected, to the second terminal of the voltage source 250, to the second terminal of capacitor C250, and to a second terminal of the voltage source 251.

According to one embodiment, device 200 comprises a first branch, arranged between the terminals N201 and N202, including a Zener diode DZ201. According to one embodiment, a cathode terminal of the diode DZ201 is coupled, preferably connected, to the terminal N201. According to one embodiment, an anode terminal of the diode DZ201 is coupled, preferably connected, to the terminal N202. According to one embodiment, this first branch further comprises a resistor R201 arranged between the anode terminal of the diode DZ201 and the terminal N202.

According to one embodiment, device 200 comprises a second branch, arranged between the terminals N201 and N202, including a varistor MOV201, i.e. a variable-resistivity resistor, and a thyristor T201. According to one embodiment, a first terminal of the varistor MOV201 is coupled, preferably connected, to the terminal N201, and a second terminal of the varistor MOV201 is coupled, preferably connected, to an anode terminal of the thyristor T201. According to one embodiment, the varistor MOV201 is a metal oxide varistor. According to one embodiment, a cathode terminal of the thyristor T201 is coupled, preferably connected, to the terminal N202. According to one embodiment, a gate terminal of the thyristor T201 is coupled to the first branch and, particularly, is coupled to the anode terminal of the Zener diode DZ201. According to one embodiment, the gate terminal of the thyristor T201 is coupled to the anode terminal of the Zener diode DZ201 via a resistor R202.

According to one embodiment, this second branch further comprises an assembly comprising a capacitor C201 and a resistor R203 parallelly arranged between the varistor MOV201 and the thyristor T201. More particularly, a first terminal of the capacitor C201 and of the resistor R203 are coupled, preferably connected, to each other and to the second terminal of the varistor MOV201, and a second terminal of the capacitor C201 and of the resistor R203 are coupled, preferably connected, to each other and to the anode terminal of the thyristor T201.

The protection device operates as follows. When an overvoltage occurs between terminals N201 and N202, a high voltage appears at the terminals of the first and second branches. This high voltage, when it is greater than the avalanche voltage of the Zener diode DZ201, is accompanied by a current which flows through the Zener diode DZ201 in reverse and which acts as a control current for the trigger of the thyristor T201. As soon as the control current of the trigger is greater than the trigger current of the thyristor T201, the thyristor T201 becomes conductive, allowing the flow of the current due to the overvoltage.

When the overvoltage stops, the overcurrent flowing through thyristor T201 also stops, but the direct current generated by power supply 250 now flows through thyristor T201 and prevents it from making it non-conductive, and this even in the absence of control current on its trigger, thyristor T201 remains conductive as long as the current flowing through it does not cancel out. This is why capacitor C201 and resistor R203 are present. Capacitor C201 charges with the current coming from power supply 250. Increasing the capacitor voltage reduces the voltage across varistor MOV201 by the same amount. When the voltage of varistor MOV201 drops below its avalanche voltage, the current flowing through thyristor T201 is greatly reduced and becomes lower than its holding current. As a result, thyristor T201 opens and is no longer conducting. Resistor R203 allows capacitor C201 to be discharged periodically to allow current to flow through this branch again during a subsequent voltage overload.

An advantage of this embodiment is that providing capacitor C201 and resistor R203 allows turning the thyristor OFF once an overvoltage was detected to be assisted.

According to one embodiment, an overvoltage protection method is a method of using the protection device 200.

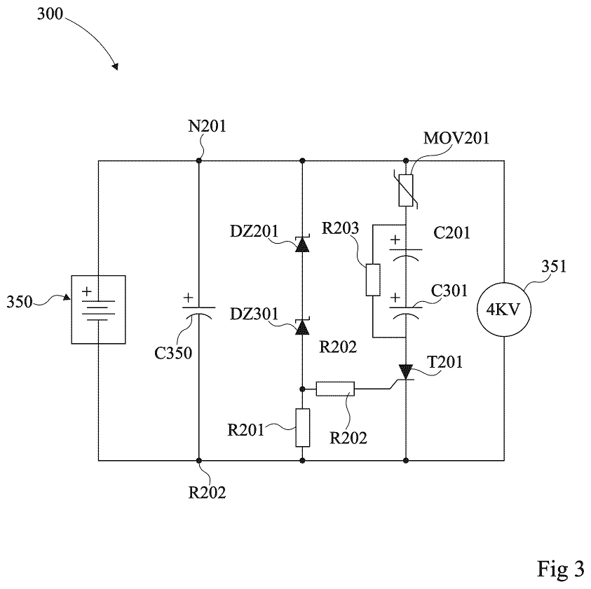

FIG. 3 is a circuit diagram of a second embodiment of an overvoltage protection device 300.

According to one example, in FIG. 3, a voltage source 350 and a capacitor C350 to be protected are also illustrated. More particularly, the capacitor C350 comprises a first terminal is coupled, preferably connected, to a first terminal of the voltage source 350, and a second terminal is coupled, preferably connected, to a second terminal of the voltage source 350.

According to one example, in FIG. 3, a voltage source 351 suitable for simulating an overvoltage is also illustrated.

The device 300 is similar to the device 200 described in connection to FIG. 2. The features common to the devices 200 and 300 are not again described in detail. Only differences between the devices 200 and 300 are highlighted.

Thus, like device 200, the device 300 comprises:
terminals N201 and N202;
the Zener diode DZ201;
resistors R201 and R202, if appropriate;
the varistor MOV201;
thyristor T201;
capacitor C201; and
resistor R203.

According to one embodiment, the device 300 further comprises a second Zener diode DZ301 serially arranged with the Zener diode DZ201. More particularly, the Zener diode DZ301 is arranged between the Zener diode DZ201 and the resistor R201.

According to one embodiment, the device 300 further comprises a second capacitor C301 serially arranged with the capacitor C201. More particularly, the capacitor C301 is serially arranged with the capacitor C201, and capacitors C201 and C301 are in parallel to resistor R203.

Adding Zener diode DZ301 and capacitor C301 allows the value of an overvoltage detected by the protection device 300 to be changed. Adding these components can also allow for better distribution of costs and component sizes in the circuit.

Operation of the device 300 is identical to protection device 200 described in connection to FIG. 2.

According to one embodiment, an overvoltage protection method is a method of using the protection device 300.

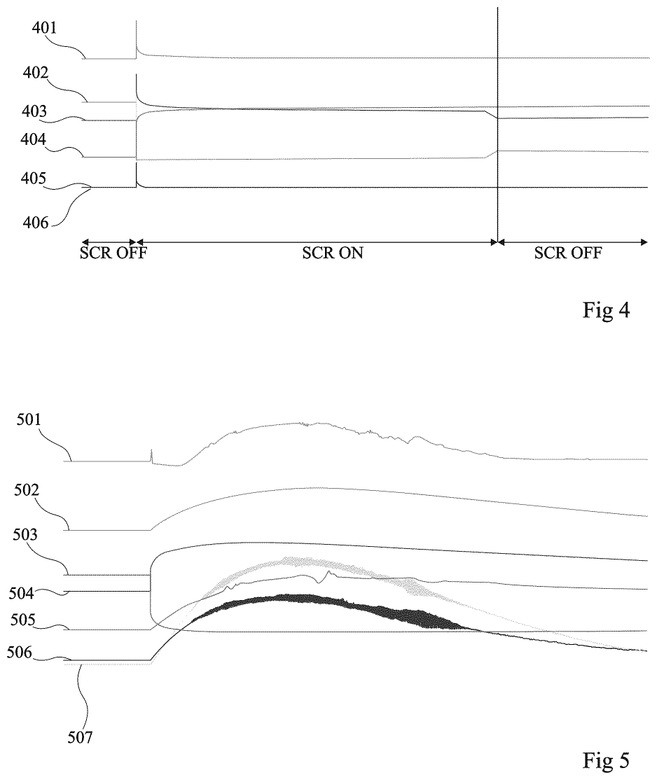

FIGS. 4 and 5 include graphs illustrating the operation of the embodiments described in connection to FIGS. 2 and 3, and in particular the embodiment described in connection to FIG. 3.

More particularly, in FIG. 4, are illustrated:
a curve 401 illustrating the evolution of the voltage across capacitor C350;
a curve 402 illustrating the evolution of the voltage across thyristor T201;
a curve 403 illustrating the evolution of the voltage across varistor MOV201;
a curve 404 illustrating the evolution of the voltage across resistor R203;
a curve 405 illustrating the evolution of the current flowing through thyristor T201; and
a curve 406 illustrating the evolution of the current of the overvoltage provided by the voltage source 351.

More particularly, in FIG. 5, are illustrated:
a curve 501 illustrating the evolution of the voltage across resistor R202;
a curve 502 illustrating the evolution of the voltage across capacitor C350;
a curve 503 illustrating the evolution of the voltage across thyristor T201;
a curve 504 illustrating the evolution of the voltage across varistor MOV201;
a curve 505 illustrating the evolution of the voltage across resistor R203;
a curve 506 illustrating the evolution of the current flowing through thyristor T201; and
a curve 507 illustrating the evolution of the current of an overvoltage provided by the voltage source 351.

As previously described, as an overvoltage occurs at the terminal N201, a high voltage flows through the first and second branches of the device 300. This voltage is combined with a current reverse-flowing through Zener diode DZ201 and operates as a current controlling the gate of the thyristor T201. This voltage also implies a current flowing through the thyristor T201 which then turns ON (SCR ON).

As the overvoltage stops, the current flowing through the thyristor also stops, but it may sometimes remain enough current to avoid turning it OFF (SCR OFF). That's why the capacitor C201 and the resistor R203 are present. The capacitor C201 charges with the remaining current, and reduces the current flowing through the thyristor T201. Resistor R203 allows the capacitor C201 to be periodically discharged to reduce the residue of the current.

One should then note that the voltage across capacitor C350 remains stable despite the occurrence of the overvoltage. According to one specific example, such an assembly can allow a high voltage device for example receiving a voltage of 600 V across its terminals, to be protected against overvoltage higher than 4000 V by keeping the potential between rails N201 and N202 under the voltage of 900 V during the discharge.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. An overvoltage protection device comprising, between a first terminal and a second terminal:
a first Zener diode;
a serial assembly comprising a varistor, a first capacitor and a thyristor, having its gate terminal coupled to the first terminal; and
a first resistor parallelly arranged with the first capacitor.

2. The overvoltage protection device of claim 1, wherein a cathode terminal of the thyristor is coupled to the second terminal, and
Wherein an anode terminal of the thyristor is coupled to the first terminal.

3. The overvoltage protection device of claim 1, wherein a cathode terminal of the first Zener diode is coupled to the first terminal, and
wherein an anode terminal of the first Zener diode is coupled to the second terminal.

4. The overvoltage protection device of claim 1, wherein the overvoltage protection device further comprises at least one second resistor serially arranged with the first Zener diode.

5. The overvoltage protection device of claim 1, wherein the overvoltage protection device further comprises at least one third resistor serially arranged between a gate of the thyristor and the second terminal.

6. The overvoltage protection device of claim 1, wherein the overvoltage protection device further comprises at least one second Zener diode serially arranged with the first Zener diode.

7. The overvoltage protection device of claim 1, wherein the overvoltage protection device further comprises at least one second capacitor serially arranged with the first capacitor.

8. A direct voltage transmission bus comprising the overvoltage protection device of claim 1 configured for protecting the direct voltage transmission bus against overvoltage.

9. The direct voltage transmission bus of claim 8, wherein the direct voltage transmission bus comprises a three-phase connector.

10. An overvoltage protection method using an overvoltage protection device comprising, between a first terminal and a second terminal:
a first Zener diode;
a serial assembly comprising a varistor, a first capacitor and a thyristor, having its gate terminal coupled to the first terminal; and
a first resistor parallelly arranged with the first capacitor.

11. The overvoltage protection method of claim 10, wherein a cathode terminal of the thyristor is coupled to the second terminal, and
Wherein an anode terminal of the thyristor is coupled to the first terminal.

12. The overvoltage protection method of claim 10, wherein a cathode terminal of the first Zener diode is coupled to the first terminal, and
wherein an anode terminal of the first Zener diode is coupled to the second terminal.

13. The overvoltage protection method of claim 10, wherein the overvoltage protection device further comprises at least one second resistor serially arranged with the first Zener diode.

14. The overvoltage protection method of claim 10, wherein the overvoltage protection device further comprises at least one third resistor serially arranged between a gate of the thyristor and the second terminal.

15. The overvoltage protection method of claim 10, wherein the overvoltage protection device further comprises at least one second Zener diode serially arranged with the first Zener diode.

16. The overvoltage protection method of claim 10, wherein the overvoltage protection device further comprises at least one second capacitor serially arranged with the first capacitor.
